(19) United States
(12) Patent Application Publication
(10) Pub. No.: US 2005/0073474 A1
(43) Pub. Date: Apr. 7, 2005

(54) Dual scan method of display panel

(76) Inventors: Hak Su Kim, Seoul (KR); Jung Bae Kim, Gyeonggi-do (KR); Young Hee Nam, Seoul (KR); Chang Jin Kim, Gyeonggi-do (KR)

Correspondence Address: FLESHNER & KIM, LLP, P.O. Box 221200, Chantilly, VA, 20153-1200, US

(21) Appl. No.: 10/404,535

(22) Filed: Apr. 2, 2003

(30) Foreign Application Priority Data
Apr. 4, 2002 (KR) P 2002-18659

(51) Int. Cl. G09G 3/20

(52) U.S. Cl. 345/55

(57) ABSTRACT

Disclosed is a dual scan method of a display panel having M data lines and N scan lines. The present invention includes the steps of dividing the N scan lines into an upper half and a lower half; and applying current to the scan lines of the upper half and the lower half respectively to scan, wherein the scan lines of the upper half and the scan lines of the lower half are sequentially scanned to be symmetrical to each other centering on a central axis of the display panel.

This application claims the benefit of the Korean Application No. P2002-18659 filed on Apr. 4, 2002, which is hereby incorporated by reference.

### BACKGROUND OF THE INVENTION

1. Field of the Invention

The present invention relates to a display panel, and more particularly, to a dual scan method of a display panel having a passive matrix structure.

2. Discussion of the Related Art

Recently, rapid progress has been made in a flat display panel field.

Specifically, flat display panels including LCD (liquid crystal display) as a leading device appears in the markets to replace CRT (cathode ray tube) having been used most widely in the display field. Lately, the flat display panels including PDP (plasma display panel), VFD (visual fluorescent display), FED (field emission display), LED (light emitting diode), EL (electroluminescence), and the like have achieved great developments.

Such a flat display panel requires a simple manufacturing process as well as high visibility and color sensation, thereby widening its application fields.

Great attention is recently paid to an organic EL display as a flat display panel which occupies a small space as well as enables to have a wide screen size.

The organic EL displays are classified into a passive matrix display and an active matrix display in accordance with panel structures.

The passive matrix display has a structure that an organic EL material is located at each intersection between column and row lines.

Hence, as an area of the passive matrix display increases, line resistance and capacitance increase to elongate an RC response time.

The RC response time slows down the operation of the display as well as reduces brightness of the display.

In order to decrease such a phenomenon, a dual scan method of scanning upper and lower parts of the display panel respectively is applied.

Such a method elongates the light-emitting time of the display to increase the brightness but to reduce the influence of the resistance and capacitance.

FIG. 1 and FIG. 2 illustrate diagrams of general dual scan methods of passive matrix display panels, respectively.

Referring to FIG. 1, a display panel having “n (natural number as a multiple of ‘2’)” scan lines is divided into an upper half and a lower half.

In this case, the upper half includes 1^{st} to a (n/2)^{th} scan lines and the lower half includes (n/2+1)^{th} to n^{th} scan lines.

For the scan lines of the upper half, a sequential scan is carried out on the first scan line to the (n/2)^{th} scan line. Simultaneously, for the scan lines of the lower half, a sequential scan is carried out on the (n/2+1)^{th} scan line to the n^{th} scan line.

On the other hand, a scan, as shown in FIG. 2, can be carried out in a direction opposite to that of the display panel shown in FIG. 1.

Namely, the scan is sequentially carried out on the scan lines of the upper half from the (n/2)^{th} to the first scan lines while the other scan is sequentially carried out on the scan lines of the lower half from the n^{th} to the (n/2+1)^{th} scan lines.

Unfortunately, the above-explained dual scan methods have the problem that strong light is instantly generated from a central part of the panel as a boundary between the upper and lower halves.

### SUMMARY OF THE INVENTION

Accordingly, the present invention is directed to a dual scan method of a display panel that substantially obviates one or more problems due to limitations and disadvantages of the related art.

An object of the present invention is to provide a dual scan method of a display panel enabling to remove strong light generated instantly from a central part of a display panel on driving the display panel by changing a scan order of scan lines.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dual scan method of a display panel having M data lines and N scan lines according to the present invention includes the steps of dividing the N scan lines into an upper half and a lower half and applying current to the scan lines of the upper half and the lower half respectively to scan, wherein the scan lines of the upper half and the scan lines of the lower half are sequentially scanned to be symmetrical to each other centering on a central axis of the display panel.

Preferably, the scan lines of the upper half and the scan lines of the lower half are sequentially scanned to be symmetrical to each other from outside to a center of the display panel.

More preferably, the scan lines of the upper half are scanned in a sequence from 1^{st} to (N/2)^{th} scan lines and the scan lines of the lower half are scanned in a sequence from N^{th} to (N/2+1)^{th} scan lines, simultaneously.

Preferably, the scan lines of the upper half and the scan lines of the lower half are sequentially scanned to be symmetrical to each other from center to outside of the display panel.

More preferably, the scan lines of the upper half are scanned in a sequence from (N/2)^{th} to 1^{st} scan lines and the scan lines of the lower half are scanned in a sequence from (N/2+1)^{th} to N^{th} scan lines, simultaneously.

Preferably, the scan lines of the upper half and the scan lines of the lower half are simultaneously scanned for one frame time.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 and FIG. 2 illustrate diagrams of general dual scan methods of passive matrix display panels, respectively; and

FIG. 3 and FIG. 4 illustrate diagrams of dual scan methods of passive matrix display panels according to the present invention, respectively.

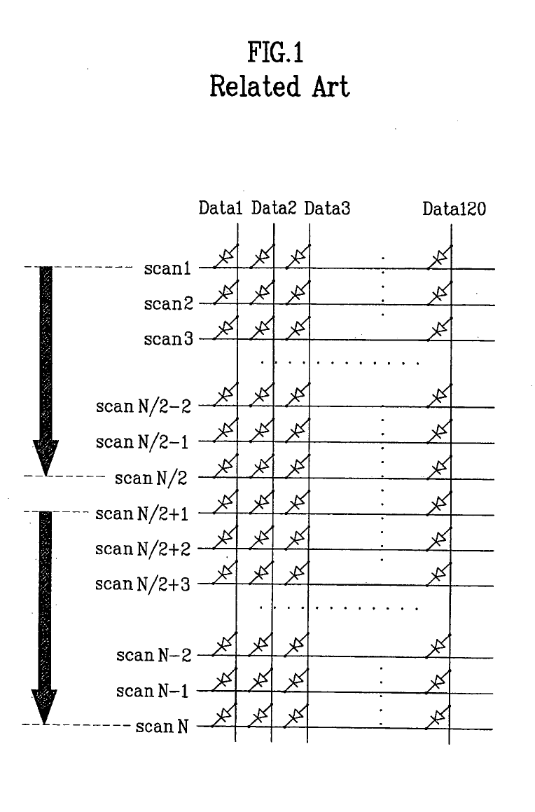

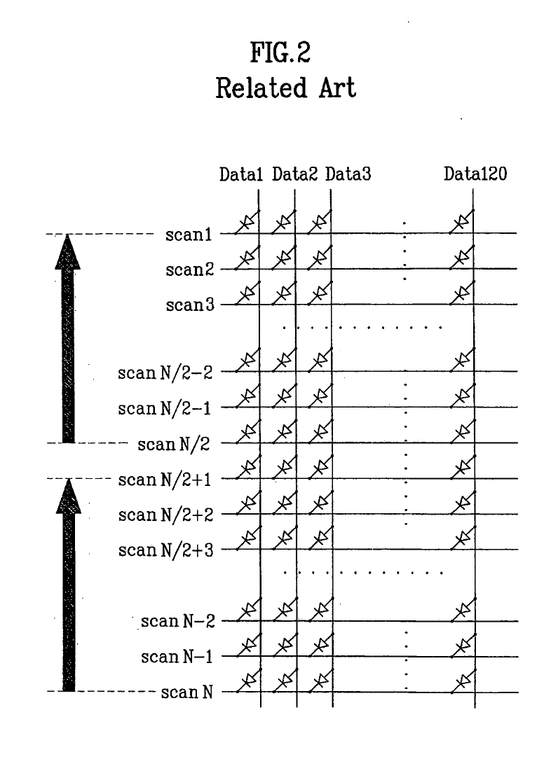

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

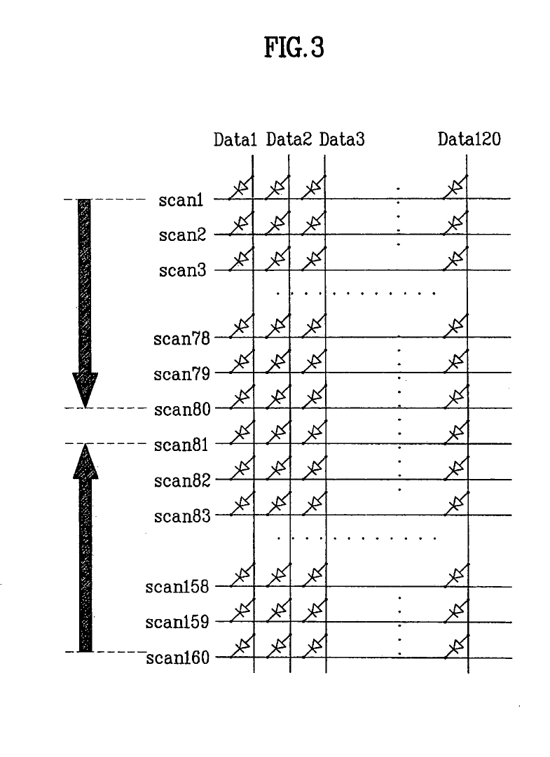

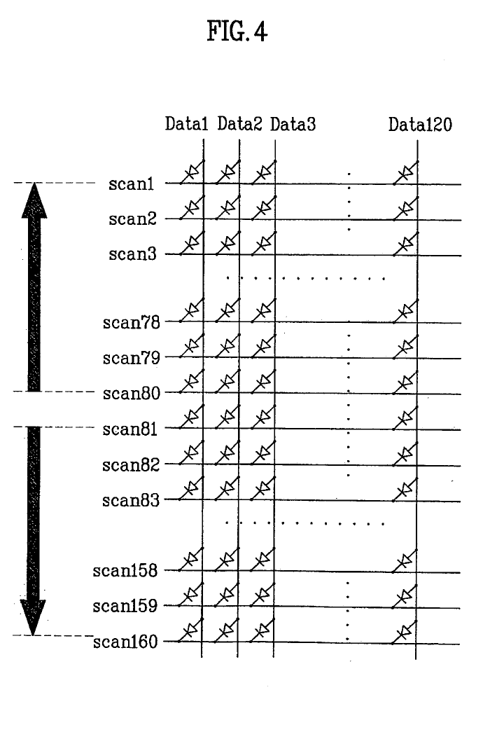

FIG. 3 and FIG. 4 illustrate diagrams of dual scan methods of passive matrix display panels according to the present invention, respectively.

Each of the display panels shown in FIG. 3 and FIG. 4 has a passive matrix structure of 120 (column lines/data lines)*160 (row lines/scan lines).

Each of the display panels of FIG. 3 and FIG. 4 carries out a dual scan on each eighty lines of upper and lower halves of scan lines.

Referring to FIG. 3, a display panel having one hundred sixty scan lines is divided into an upper half and a lower half.

Namely, the upper half includes 1^{st} to 80^{th} scan lines and the lower half includes 81^{st} to 160^{th} scan lines.

A scan line driving sequence of the above-constituted display panel according to the present invention is described as follows.

Referring to FIG. 3, a sequential scan is carried out on the scan lines (1^{st} to 80^{th} scan lines) of the upper half and the scan lines (81^{st} to 160^{th} scan lines) of the lower half to be symmetrical on a central axis of the panel.

Namely, the scan is carried out so that the scan lines of the upper half and the other scan lines of the lower half are symmetrical to each other in a direction from outside to center of the panel.

The scan is sequentially carried out on the scan lines of the upper half from the 1^{st} to 80^{th} scan lines while the other scan is sequentially carried out on the scan lines of the lower half from the 160^{th} to 81^{st} scan lines of the lower half.

Hence, the scans are simultaneously carried out on the scan lines of the upper and lower halves for 1 frame time.

More specifically, in a 1^{st} scan time, the 1^{st} scan line of the upper half and the 160^{th} scan line of the lower half are simultaneously scanned.

Subsequently, in a 2nd scan time, the 2nd scan line of the upper half and the 159^{th} scan line of the lower half are simultaneously scanned.

Next, in a 3^{rd} scan time, the 3^{rd} scan line of the upper half and the 158^{th} scan line of the lower half are simultaneously scanned.

In the above-explained sequence manner, the respective scan lines are consecutively scanned.

In a 78^{th} scan time, the 78^{th} scan line of the upper half and the 83^{rd} scan line of the lower half are simultaneously scanned. And, in a 79^{th} scan time, the 80^{th} scan line of the upper half and the 81^{st} scan line of the lower half are simultaneously scanned.

Finally, in an 80^{th} scan time, the 80^{th} scan line of the upper half and the 81^{st} scan line of the lower half are simultaneously scanned to finish the scan for one frame.

And, in the subsequent frame, the scan is carried out in the above-explained same manner to make a corresponding pixel emit light.

Using such a scan sequence can eliminate the instant light generated from a center of the panel.

On the other hand, FIG. 4 illustrates another embodiment of the present invention.

Referring to FIG. 4, a display panel having one hundred sixty scan lines is divided into an upper half and a lower half.

Namely, the upper half includes 1^{st} to 80^{th} scan lines and the lower half includes 81^{st} to 160^{th} scan lines.

The scan lines (1^{st} to 80^{th} scan lines) of the upper half and the scan lines (81^{st} to 160^{th} scan lines) of the lower half are sequentially scanned to be symmetrical to each other on a central axis of the panel.

Namely, the scan is carried out so that the scan lines of the upper half and the other scan lines of the lower half are symmetrical to each other in a direction from center to outside of the panel.

The scan is sequentially carried out on the scan lines of the upper half from the 80^{th} to 1^{st} scan lines while the other scan is sequentially carried out on the scan lines of the lower half from the 81^{st} to 160^{th} scan lines of the lower half.

Hence, the scans are simultaneously carried out on the scan lines of the upper and lower halves for 1 frame time.

More specifically, in a 1^{st} scan time, the 80^{th} scan line of the upper half and the 81^{st} scan line of the lower half are simultaneously scanned.

Subsequently, in a 2^{nd} scan time, the 79^{th} scan line of the upper half and the 82^{nd} scan line of the lower half are simultaneously scanned.

Next, in a 3^{rd} scan time, the 78^{th} scan line of the upper half and the 83^{rd} scan line of the lower half are simultaneously scanned.

In the above-explained sequence manner, the respective scan lines are consecutively scanned.

In a 78^{th} scan time, the 3^{rd} scan line of the upper half and the 158^{th} scan line of the lower half are simultaneously scanned. And, in a 79^{th} scan time, the 2^{nd} scan line of the upper half and the 159^{th} scan line of the lower half are simultaneously scanned.

Finally, in an 80^{th} scan time, the 1^{st} scan line of the upper half and the 160^{th} scan line of the lower half are simultaneously scanned to finish the scan for one frame.

And, in the subsequent frame, the scan is carried out in the above-explained same manner to make a corresponding pixel emit light.

Using such a scan sequence can eliminate the instant light generated from a center of the panel.

Accordingly, the dual scan method of the passive matrix display panel according to the present invention enables to eliminate the strong light generated instantly from the central part of the display panel by scanning the panel symmetrically on the central axis of the display panel.

It will be apparent to those skilled in the art that various modifications and variations can be made in the present invention. Thus, it is intended that the present invention covers the modifications and variations of this invention provided they come within the scope of the appended claims and their equivalents.

1. A dual scan method of a display panel, the display panel having M data lines and N scan lines, the dual scan method comprising the steps of:
dividing the N scan lines into an upper half and a lower half; and
applying current to the scan lines of the upper half and the lower half respectively to scan, wherein the scan lines of the upper half and the scan lines of the lower half are sequentially scanned to be symmetrical to each other centering on a central axis of the display panel.

2. The dual scan method of claim 1, wherein the scan lines of the upper half and the scan lines of the lower half are sequentially scanned to be symmetrical to each other from outside to a center of the display panel.

3. The dual scan method of claim 2, wherein the scan lines of the upper half are scanned in a sequence from 1^{st} to (N/2)^{th} scan lines and the scan lines of the lower half are scanned in a sequence from N^{th} to (N/2+1)^{th} scan lines, simultaneously.

4. The dual scan method of claim 1, wherein the scan lines of the upper half and the scan lines of the lower half are sequentially scanned to be symmetrical to each other from center to outside of the display panel.

5. The dual scan method of claim 4, wherein the scan lines of the upper half are scanned in a sequence from (N/2)^{th} to 1^{st} scan lines and the scan lines of the lower half are scanned in a sequence from (N/2+1)^{th} to N^{th} scan lines, simultaneously.

6. The dual scan method of claim 1, wherein the scan lines of the upper half and the scan lines of the lower half are simultaneously scanned for one frame time.
